(19) United States
(12) Patent Application Publication
(10) Pub. No.: US 2026/0296427 A1
(43) Pub. Date: Oct. 1, 2026

(54) CONTROL SYSTEM FOR VEHICLE

(71) Applicant: MAZDA MOTOR CORPORATION, Hiroshima (JP)

(72) Inventors: Tomokuni KUSUNOKI, Aki-gun (JP); Yutaro FUKUDA, Aki-gun (JP); Hiroshi SHINOZUKA, Aki-gun (JP); Hiroyuki ASAKURA, Aki-gun (JP)

(73) Assignee: MAZDA MOTOR CORPORATION, Hiroshima (JP)

(21) Appl. No.: 19/547,754

(22) Filed: Feb. 24, 2026

(30) Foreign Application Priority Data
Mar. 25, 2025 (JP) 2025-049711

(51) Int. Cl. B60W 30/18; B60W 10/02; B60W 10/06; B60W 10/08; B60W 10/10; B60W 20/13; B60W 20/15

(52) U.S. Cl. CPC B60W 30/18009; B60W 10/026; B60W 10/06; B60W 10/08; B60W 10/10; B60W 20/13; B60W 20/15; B60W 2510/107; B60W 2510/244; B60W 2520/10

(57) ABSTRACT

A control system for a vehicle includes: an engine and a motor generating torque for driving a vehicle; a first clutch CL1 provided between the engine and the motor in an engageable/disengageable manner; a transmission, a torque converter, and a lock-up clutch provided on a power transmission path between the motor and the drive wheel; and a controller circuitry controlling the engine, the motor, the first clutch, and the lock-up clutch, in which the controller circuitry causes engagement of the lock-up clutch and disengagement of the frictional engagement element in the case where a temperature of the torque converter becomes equal to or higher than a predetermined temperature while the vehicle travels on an uphill road by using at least the torque of the engine.

### CROSS REFERENCE TO RELATED APPLICATION

This application claims priority under 35 U.S.C. § 119(a) to Japanese Application No. JP2025-049711, filed in Japan on Mar. 25, 2025, the entire contents of which is hereby incorporated by reference into the present application.

### TECHNICAL FIELD

The present invention relates to a control system for a vehicle that includes an engine, a motor, and a torque converter and a lock-up clutch that are provided between the motor and drive wheels.

### BACKGROUND ART

This type of technique is described in Patent Literature 1, for example. Patent Literature 1 discloses a technique of releasing a lock-up clutch in a hybrid vehicle that includes an internal combustion engine (an engine), a motor generator, an automatic transmission, a torque converter, and the lock-up clutch during travel on an uphill road. In this technique, a driver is prevented from feeling discomfort due to a sense of deceleration while traveling on an uphill road, and a feeling of traveling is thereby improved.

### CITATION LIST

### Patent Literature

[Patent Literature 1] JP2006-151307A

### SUMMARY OF INVENTION

### Technical Problem

In the vehicle having the torque converter as described above, when traveling on an uphill road by using at least the torque of the engine (the torque of the motor may be used in addition to the engine), a heat generation amount of the torque converter is possibly increased due to slippage of a turbine in the torque converter. Since a vehicle having a motor or a battery is required to cool them, cooling capacity available for the torque converter is reduced, and it is thus considered that it is only necessary to suppress the heat generation of the torque converter during hill climbing.

The invention has been made to solve the above-described problem in the related art, and an object thereof is to suppress heat generation of a torque converter during hill climbing in a vehicle control system for a vehicle including an engine, a motor, and a torque converter provided between the motor and drive wheels.

### Solution to Problem

In order to achieve the above object, the invention is a control system for a vehicle and includes: an engine and a motor that generate torque for driving a vehicle; a frictional engagement element that is provided between the engine and the motor in an engageable/disengageable manner; a transmission, a torque converter, and a lock-up clutch that are provided on a power transmission path between the motor and a drive wheel of the vehicle; and controller circuitry configured to control the engine, the motor, the frictional engagement element, and the lock-up clutch, in which the controller circuitry is configured to engage the lock-up clutch and disengage the frictional engagement element in the case where a temperature of the torque converter becomes equal to or higher than a predetermined temperature while the vehicle travels on an uphill road by using at least the torque of the engine.

In the present invention configured as described above, the lock-up clutch is engaged, and the frictional engagement element is disengaged in the case where the temperature of the torque converter becomes relatively high during hill climbing using at least the torque of the engine (in this case, the frictional engagement element is engaged). Since transmission loss in the torque converter is suppressed by engaging the lock-up clutch just as described, heat generation of the torque converter during hill climbing can be suppressed. In addition, since transmission of the engine torque to a downstream side is interrupted by disengaging the frictional engagement element, only the motor torque is transmitted to the downstream side. Thus, the vehicle can climb by using the motor torque, and, as a result, an engine stall, which is caused by operation of the engine at a low speed during hill climbing, can be prevented.

In the invention, preferably, the controller is configured to engage the lock-up clutch, disengage the frictional engagement element, and cause the engine to idle.

According to the invention configured as described above, it is no longer necessary to secure surplus power of the motor for an engine start, and the vehicle can reliably climb by the motor torque.

In the invention, preferably, the controller is configured to engage the lock-up clutch, disengage the frictional engagement element, and increase the torque of the motor.

According to the invention configured as described above, the vehicle can reliably climb by the motor torque by increasing the motor torque.

In the invention, preferably, the controller is configured to engage the lock-up clutch and disengage the frictional engagement element when a road surface gradient of the uphill road is equal to or greater than a predetermined value. According to the invention configured as described above, it is possible to engage the lock-up clutch and disengage the frictional engagement element on a relatively steep uphill road on which the heat generation of the torque converter occurs.

In the invention, preferably, the controller is configured to engage the lock-up clutch and disengage the frictional engagement element when a vehicle speed of the vehicle is lower than a predetermined speed.

According to the invention configured as described above, it is possible to engage the lock-up clutch and disengage the frictional engagement element at such a relatively low vehicle speed that the heat generation of the torque converter occurs.

In the present invention, preferably, the controller is configured to engage the lock-up clutch and disengage the frictional engagement element when an SOC of a battery that supplies electric power to the motor is equal to or greater than a predetermined value.

According to the invention configured as described above, when the SOC (a charge amount) of the battery is an amount capable of causing the vehicle to climb by the motor torque using the electric power of the battery, it is possible to engage the lock-up clutch and disengage the frictional engagement element.

In the present invention, preferably, the controller is configured to disengage the lock-up clutch and engage the frictional engagement element in the case where a temperature of the torque converter becomes lower than a predetermined temperature after the lock-up clutch is engaged and the frictional engagement element is disengaged.

According to the invention configured as described above, when the temperature of the torque converter is relatively low and it is no longer necessary to suppress the heat generation of the torque converter, it is possible to disengage the lock-up clutch and engage the frictional engagement element.

In the present invention, preferably, the controller is configured to engage the frictional engagement element in the case where a vehicle speed of the vehicle becomes equal to or higher than a predetermined speed after the lock-up clutch is engaged and the frictional engagement element is disengaged.

According to the invention configured as described above, when the vehicle speed is relatively high and it is no longer necessary to suppress the heat generation of the torque converter, it is possible to disengage the lock-up clutch and engage the frictional engagement element.

In the present invention, preferably, the controller is configured to disengage the lock-up clutch and engage the frictional engagement element in the case where an SOC of a battery that supplies electric power to the motor becomes less than a predetermined value after the lock-up clutch is engaged and the frictional engagement element is disengaged.

According to the invention configured as described above, when the SOC (the charge amount) of the battery becomes an amount incapable of causing the vehicle to climb by the motor torque using the electric power of the battery, hill climbing by using the engine torque is enabled by disengaging the lock-up clutch and engaging the frictional engagement element.

### Advantageous Effects of Invention

According to the invention, in the control system for the vehicle that includes the engine, the motor, and the torque converter provided between the motor and the drive wheel, the heat generation of the torque converter during hill climbing can be suppressed.

### BRIEF DESCRIPTION OF DRAWINGS

FIG. 1 is a schematic configuration view of a control system for a vehicle according to an embodiment of the invention.

FIG. 2 is a block diagram illustrating an electrical configuration of the control system for the vehicle according to the embodiment of the invention.

FIG. 3 is a time chart illustrating hill-climbing control according to an embodiment of the invention.

FIG. 4 is a flowchart illustrating hill-climbing control start determination processing according to the embodiment of the invention.

FIG. 5 is a flowchart illustrating hill-climbing control termination determination processing according to the embodiment of the invention.

### DESCRIPTION OF EMBODIMENTS

Hereinafter, a control system for a vehicle according to an embodiment of the invention will be described with reference to the accompanying drawings.

### System Configuration

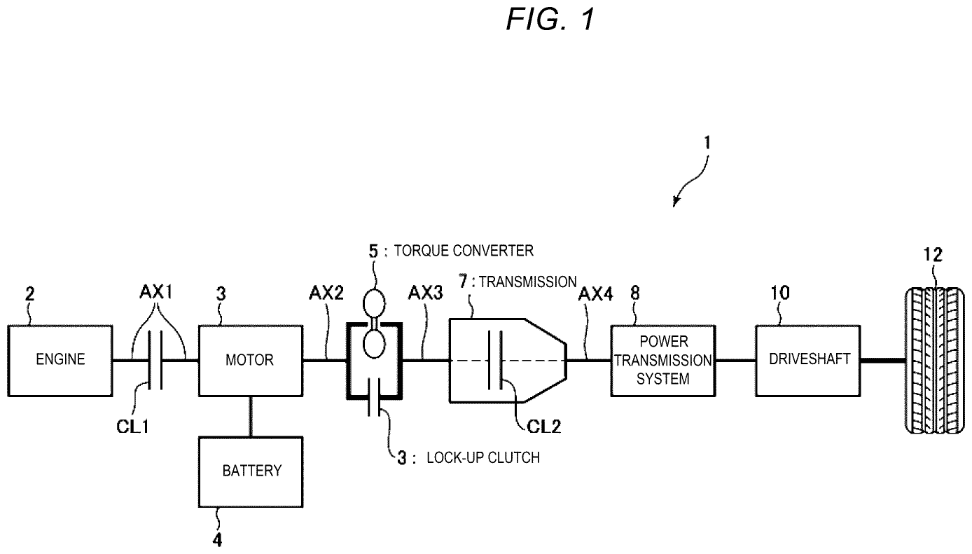

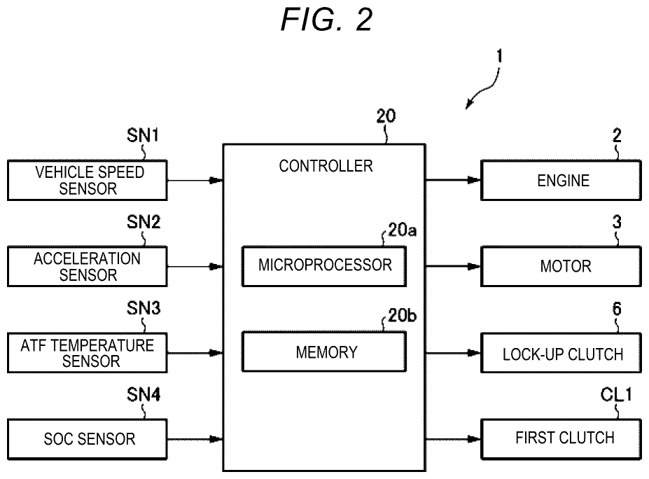

First, a configuration of the control system for the vehicle according to the present embodiment will be described with reference to FIGS. 1 and 2. FIG. 1 is a configuration view schematically illustrating the control system for the vehicle according to the present embodiment, and FIG. 2 is a block diagram illustrating an electrical configuration of the control system for the vehicle according to the present embodiment.

As illustrated in FIG. 1, the control system 1 for the vehicle mainly includes: an engine (an internal combustion engine) 2 that generates torque for driving the vehicle; a motor 3 that is provided on a downstream side of the engine 2 in a power transmission path of the vehicle and generates torque for driving the vehicle; a battery 4 that exchanges electric power with the motor 3 via an unillustrated inverter and the like; a transmission (an automatic transmission) 7 that is provided on a downstream side of the motor 3 in the power transmission path of the vehicle and changes a rotational frequency of the engine 2 and/or the motor 3; a power transmission system 8 that transmits the torque from the transmission 7 to a downstream side; a driveshaft 10 that drives a drive wheel 12 by using the torque from the power transmission system 8; and the drive wheel 12. The vehicle is configured as a hybrid vehicle that uses the engine 2 and the motor 3 as power sources.

An output shaft of the engine 2 and a rotation shaft of the motor 3 are coaxially coupled by a shaft AX1 via an engageable/disengageable first clutch CL1. This first clutch CL1 switches between transmission and interruption of the torque between the engine 2 and the motor 3. For example, the first clutch CL1 is configured by a dry multi-plate clutch capable of changing transmission torque capacity by controlling a clutch hydraulic oil flow rate and a clutch hydraulic oil pressure by a motor (not illustrated) in a continuous or stepwise manner. The first clutch CL1 corresponds to an example of the “frictional engagement element” in the invention. However, as this frictional engagement element, a brake may be used instead of the clutch.

A torque converter 5 and a lock-up clutch 6 are provided between the motor 3 and the transmission 7. In other words, the transmission 7 is configured as a torque converter-type AT with a lock-up clutch. The torque converter 5 is configured to couple a shaft AX2, which is coupled to the rotation shaft of the motor 3, and a shaft AX3, which is coupled to a rotation shaft of the transmission 7, and the lock-up clutch 6 is configured to fasten these shaft AX2 and shaft AX3. For example, the torque converter 5 includes: a pump (not illustrated) that is fixed to a case (not illustrated); and a turbine (not illustrated) that is driven by the pump, rotation of the turbine is output to the transmission 7 via the shaft AX3, and the lock-up clutch 6 is configured to directly couple the turbine and the shaft AX2 via the case of the torque converter 5.

The transmission 7 has one or more planetary gears therein, and has a function to automatically switch a gear stage (a transmission ratio) according to a vehicle speed, an engine speed, and the like. The transmission 7 also includes an engageable/disengageable second clutch CL2 therein, and this second clutch CL2 can switch between transmission and interruption of the torque between the upstream side (the engine 2 and the motor 3) of the transmission 7 and the downstream side (the drive wheel 12 and the like) of the transmission 7. For example, the second clutch CL2 is also configured by a dry multi-plate clutch capable of changing the transmission torque capacity by controlling the clutch hydraulic oil flow rate and the clutch hydraulic oil pressure by the motor (not illustrated) in a continuous or stepwise manner. The second clutch CL2 is actually configured by a large number of clutches that are used to switch among the various gear stages in the transmission 7.

The power transmission system 8 receives the torque via an output shaft AX4 of the transmission 7. The power transmission system 8 is configured to include a differential gear, a final gear, and the like that distribute a driving force to a pair of the left and right drive wheels 12.

The above vehicle can switch a travel mode by switching between the engagement and the disengagement of the first clutch CL1. That is, the vehicle has: a travel mode in which the first clutch CL1 is set into a disengaged state and the vehicle travels by using the torque of the motor 3 without using the torque of the engine 2; and a travel mode in which the first clutch CL1 is set into an engaged state and the vehicle travels by using at least the torque of the engine 2. The former travel mode is a so-called EV travel mode, and the latter travel mode is an engine travel mode, in which the vehicle travels by using only the torque of the engine 2, or a hybrid travel mode, in which the vehicle travels by using the torque of both the engine 2 and the motor 3.

Next, as illustrated in FIG. 2, the control system 1 for the vehicle according to the present embodiment further includes a controller 20 which is configured by a circuit and is based on a well-known microcomputer. The controller 20 includes: one or more processors 20a as a central processing unit (CPU) that executes a program; memory 20b that includes random access memory (RAM) and read only memory (ROM) to store the program and data; an input-output bus that inputs/outputs an electric signal; and the like. For example, the controller 20 is configured by an electronic control unit (ECU) and the like. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium, such as a CD-ROM or DVD, and/or the memory of a FPGA or ASIC.

The controller 20 receives signals from: a vehicle speed sensor SN1 that detects the vehicle speed of the vehicle; an acceleration sensor SN2 that detects acceleration of the vehicle; an automatic transmission fluid (ATF) temperature sensor SN3 that detects a temperature of the ATF as automatic transmission oil (corresponding to lubricating oil) in the transmission 7; and a state of charge (SOC) sensor SN4 that detects the SOC indicating state of charge of the battery 4. Based on these signals, the controller 20 controls the engine 2, the motor 3, the lock-up clutch 6, and the first clutch CL1. The SOC of the battery 4 is not limited to being detected by the SOC sensor SN4, and the SOC may be calculated on the basis of balance between charging and discharging in the battery 4.

### Control Details

Next, in the present embodiment, a specific description will be made on control executed by the controller 20. In the present embodiment, in the case where the vehicle is traveling on an uphill road by using at least the engine torque (in this case, the first clutch CL1 is engaged, and typically, during hill climbing in the hybrid travel mode), and a temperature of the torque converter 5 becomes relatively high, the controller 20 executes such control to engage the lock-up clutch 6 and disengage the first clutch CL1 (hereinafter, simply referred to as “hill-climbing control”). By engaging the lock-up clutch 6 in this manner, transmission loss in the torque converter 5 is suppressed, and thus heat generation of the torque converter 5 can be suppressed. In addition, by disengaging the first clutch CL1, the transmission of the engine torque to the downstream side is interrupted, and only the motor torque is transmitted to the downstream side. Thus, the vehicle can climb by using only the motor torque. When the engine torque is used during hill climbing, the engine 2 possibly stalls due to a low speed thereof at the low vehicle speed. However, when the first clutch CL1 is disengaged, and the engine 2 is disconnected for hill climbing by using the motor torque, such an engine stall can be prevented.

In the present embodiment, in the case where the lock-up clutch 6 is engaged and the first clutch CL1 is disengaged as described above, the motor torque is increased for hill climbing by using the motor 3 while the engine 2 idles. By causing the engine 2 to idle without being stopped as described above, it is not necessary to secure surplus power of the motor 3 for an engine start. Accordingly, the vehicle can reliably climb the hill by the torque of the motor 3.

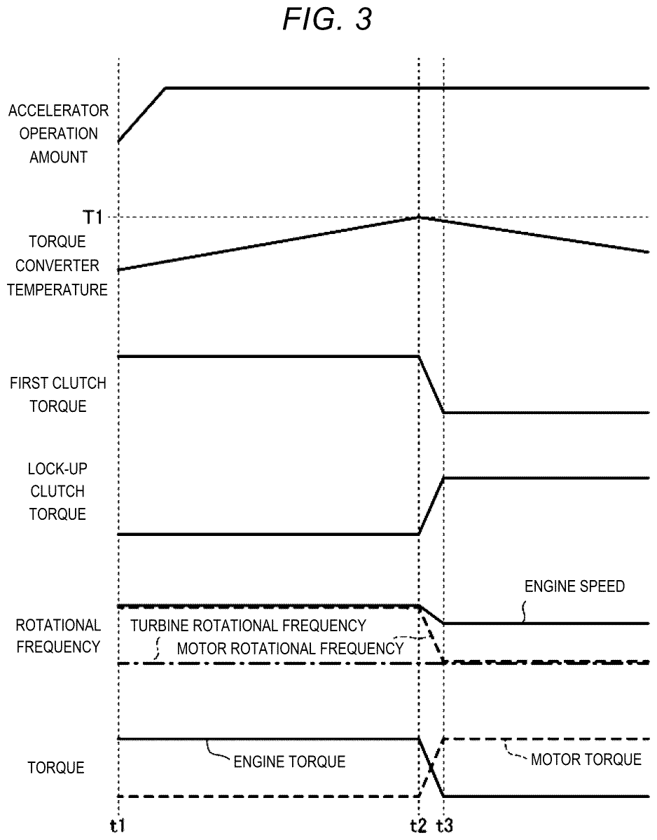

Next, a time chart illustrating the hill-climbing control according to the present embodiment will be described with reference to FIG. 3. FIG. 3 illustrates, in order from the top, an accelerator operation amount, a temperature of the torque converter 5 (hereinafter appropriately referred to as a “torque converter temperature”), the torque of the first clutch CL1 (transmission torque), the torque of the lock-up clutch 6 (transmission torque), the rotational frequency, and the torque. In FIG. 3, in regard to the rotational frequency, a solid line indicates the engine speed, a broken line indicates the motor rotational frequency, a one-dot chain line indicates a turbine rotational frequency in the torque converter 5, and, in regard to the torque at the bottom, a solid line indicates the engine torque, and a broken line indicates the motor torque.

As illustrated in FIG. 3, first, at time t1, the accelerator operation amount is increased to cause the vehicle to climb. In this case, since the vehicle is set in the hybrid travel mode, the first clutch CL1 is engaged, and the engine speed and the motor rotational frequency match each other. On the other hand, since the lock-up clutch 6 is disengaged, the turbine of the torque converter 5 is in a slipping state. This is because the vehicle is climbing at a low speed. Accordingly, from the time t1 onward, the torque converter temperature is increased, and, at time t2, the torque converter temperature reaches a relatively high predetermined temperature T1.

In the present embodiment, at such time t2, in order to disengage the first clutch CL1, the transmission torque thereof is reduced, and in order to engage the lock-up clutch 6, the transmission torque thereof is increased. Since the engine 2 is idling at the same time, the engine speed and the engine torque are reduced (more specifically, the engine speed becomes an idle speed while the engine torque becomes approximately 0), and the motor torque is increased for hill climbing by using the motor 3. Then, at time t3, the disengagement of the first clutch CL1 and the engagement of the lock-up clutch 6 are completed. Since the lock-up clutch 6 is engaged in this way, the motor rotational frequency matches the turbine rotational frequency. According to the hill-climbing control in the present embodiment as described so far, from the time t2 onward, the heat generation of the torque converter 5 is suppressed, and the torque converter temperature is reduced.

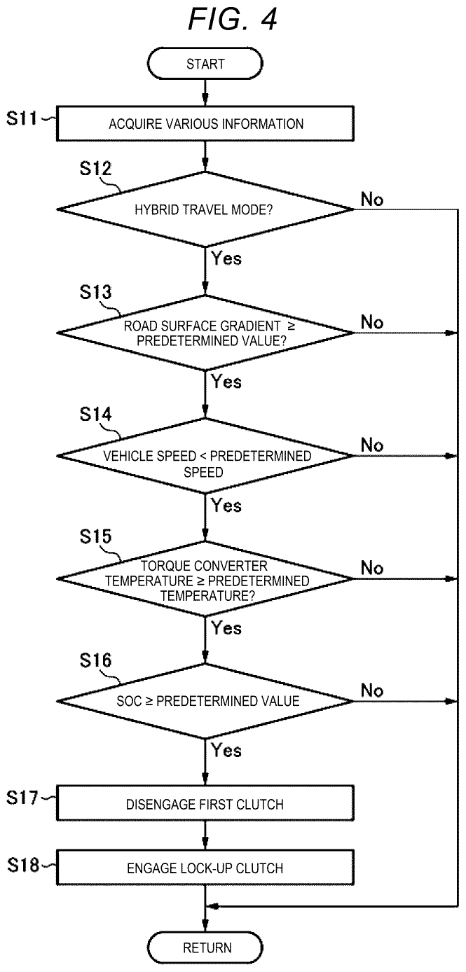

Next, a flowchart illustrating start determination processing for determining whether to start the hill-climbing control according to the present embodiment will be described with reference to FIG. 4. This flow is repeatedly executed by the controller 20 in a predetermined cycle. More specifically, the processor 20a in the controller 20 reads the program stored in the memory 20b to execute the program, and thereby realizes the control for the flow.

First, in step S11, the controller 20 acquires various types of information in the control system 1 for the vehicle. In particular, the controller 20 acquires the vehicle speed detected by the vehicle speed sensor SN1, the acceleration detected by the acceleration sensor SN2, the ATF temperature detected by the ATF temperature sensor SN3, and the SOC of the battery 4 detected by the SOC sensor SN4.

Next, in step S12, the controller 20 determines whether the vehicle is set in the hybrid travel mode. For example, the controller 20 determines whether the vehicle is set in the hybrid travel mode on the basis of a state of the first clutch CL1 and a relationship between the engine speed and the motor rotational frequency. In this example, the controller 20 determines that the vehicle is set in the hybrid travel mode when the first clutch CL1 is in the engaged state or when the engine speed and the motor rotational frequency match each other. If the controller 20 determines that the vehicle is set in the hybrid travel mode (step S12: Yes), the processing proceeds to Step S13. If it is not determined that the vehicle is set in the hybrid travel mode (Step S12: No), for example, if the vehicle is set in the EV travel mode, the processing exits this flow.

Next, in step S13, the controller 20 determines whether a road surface gradient of a travel road of the vehicle is equal to or greater than a predetermined value. Here, the controller 20 determines whether the travel road of the vehicle is a relatively steep uphill road on which the hill-climbing control according to the present embodiment should be executed. For example, the controller 20 calculates the road surface gradient on the basis of the acceleration acquired in step S11. For example, 30% is applied as the predetermined value that is used to determine the road surface gradient. The road surface gradient is not limited to being calculated on the basis of the acceleration, and the road surface gradient may be detected by using a gradient sensor. As a result of such step S13, if the controller 20 determines that the road surface gradient is equal to or greater than the predetermined value (step S13: Yes), the processing proceeds to step S14. If it is not determined that the road surface gradient is equal to or greater than the predetermined value (step S13: No), that is, if the road surface gradient is less than the predetermined value, the processing exits this flow.

Next, in step S14, the controller 20 determines whether the vehicle speed acquired in step S11 is lower than a predetermined speed. When the vehicle speed is relatively low, the turbine slips, a rotational frequency difference thereby occurs in the torque converter 5, and the torque converter 5 generates the heat. Meanwhile, when the vehicle speed is relatively high, the turbine rotational frequency is increased, the rotational frequency difference in the torque converter 5 is thus eliminated, and the torque converter 5 does not generate the heat. Thus, in step S14, it is determined whether the vehicle speed is relatively low such that the torque converter 5 generates the heat. For example, the predetermined speed that is used to determine the vehicle speed is 10 km/h. As a result of such step S14, if the controller 20 determines that the vehicle speed is lower than the predetermined speed (step S14: Yes), the processing proceeds to step S15. If it is not determined that the vehicle speed is lower than the predetermined speed (step S14: No), that is, if the vehicle speed is equal to or higher than the predetermined speed, the processing exits this flow.

Next, in step S15, the controller 20 determines whether the torque converter temperature is equal to or higher than a predetermined temperature. Here, the controller 20 determines whether the torque converter temperature is a relatively high temperature at which the hill-climbing control according to the present embodiment should be executed, that is, whether the torque converter temperature should be reduced. For example, the controller 20 calculates the torque converter temperature from a slip amount in the torque converter 5. In this case, the controller 20 may calculate the torque converter temperature in consideration of the ATF temperature that is acquired in step S11. The torque converter temperature is not limited to being calculated, and the torque converter temperature may be detected by using a temperature sensor. As a result of such step S15, if the controller 20 determines that the torque converter temperature is equal to or higher than the predetermined temperature (step S15: Yes), the processing proceeds to step S16. If it is not determined that the torque converter temperature is equal to or higher than the predetermined temperature (step S15: No), that is, if the torque converter temperature is lower than the predetermined temperature, the processing exits this flow.

Next, in step S16, the controller 20 determines whether the SOC acquired in step S11 is equal to or greater than a predetermined value. Here, the controller 20 determines whether the SOC (a charge amount) of the battery 4 is an amount with which the vehicle can climb by the motor torque using the electric power of the battery 4. As a result of step S16, if the controller 20 determines that the SOC is equal to or greater than the predetermined value (step S16: Yes), the processing proceeds to step S17. If it is not determined that the SOC is equal to or greater than the predetermined value (step S16: No), that is, if the SOC is less than the predetermined value, the processing exits this flow.

When all the conditions in steps S12 to S16 described above are satisfied, the processing proceeds to step S17 in order for the controller 20 to execute the hill-climbing control according to the present embodiment. In step S17, the controller 20 executes control to disengage the first clutch CL1, and simultaneously executes control to engage the lock-up clutch 6 in step S18. For example, in order to engage/disengage these clutches, the controller 20 controls hydraulic pressures applied to the clutches to adjust the transmission torque thereof. Then, after step S18, the controller 20 exits this flow.

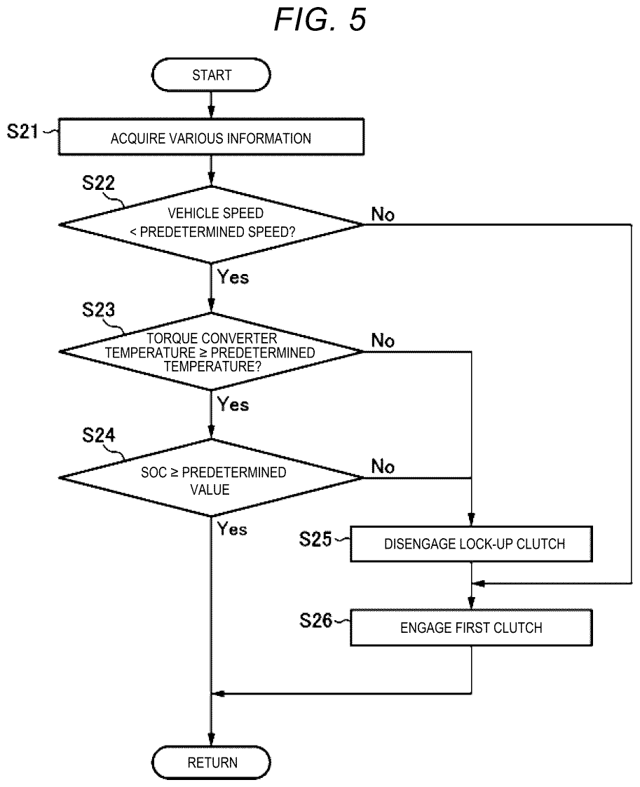

Next, a flowchart illustrating termination determination processing for determining whether to terminate the hill-climbing control according to the present embodiment will be described with reference to FIG. 5. This flow is also repeatedly executed by the controller 20 in a predetermined cycle.

First, in step S21, the controller 20 acquires the various types of information in the control system 1 for the vehicle. In particular, the controller 20 acquires the vehicle speed detected by the vehicle speed sensor SN1, the acceleration detected by the acceleration sensor SN2, the ATF temperature detected by the ATF temperature sensor SN3, and the SOC of the battery 4 detected by the SOC sensor SN4.

Next, in step S22, the controller 20 determines whether the vehicle speed acquired in step S21 is lower than a predetermined speed. An intention of the determination in this step S22 is the same as that of the determination in step S14 in FIG. 4. As a result of step S22, if the controller 20 determines that the vehicle speed is lower than the predetermined speed (step S22: Yes), in order to continue the hill-climbing control according to the present embodiment, the processing proceeds to step S23. On the other hand, if the controller 20 does not determine that the vehicle speed is lower than the predetermined speed (step S22: No), that is, if the vehicle speed is equal to or higher than the predetermined speed, the processing proceeds to step S26. In this case, since the vehicle speed is relatively high, the torque converter 5 does not generate the heat. Accordingly, in step S26, in order to terminate the hill-climbing control according to the present embodiment, the controller 20 executes control to engage the first clutch CL1. In the case where the vehicle speed is relatively high, there is no problem even when the lock-up clutch 6 remains to be engaged. Thus, the controller 20 maintains the engagement of the lock-up clutch 6.

Next, in step S23, the controller 20 determines whether the torque converter temperature is equal to or higher than a predetermined temperature. An intention of the determination in this step S23 is the same as that of the determination in step S15 in FIG. 4. As a result of step S23, if the controller 20 determines that the torque converter temperature is equal to or higher than the predetermined temperature (step S23: Yes), in order to continue the hill-climbing control according to the present embodiment, the processing proceeds to step S24. On the other hand, if the controller 20 does not determine that the torque converter temperature is equal to or higher than the predetermined temperature (step S23: No), that is, if the torque converter temperature is lower than the predetermined temperature, the processing proceeds to step S25. In this case, since the torque converter temperature is relatively low, it can be said that it is not necessary to suppress the heat generation of the torque converter 5. Accordingly, in step S25, in order to terminate the hill-climbing control according to the present embodiment, the controller 20 executes control to disengage the lock-up clutch 6, and simultaneously executes the control to engage the first clutch CL1 in step S26.

Next, in step S24, the controller 20 determines whether the SOC acquired in step S21 is equal to or greater than a predetermined value. An intention of the determination in this step S24 is the same as that of the determination in step S16 in FIG. 4. As a result of step S24, if the controller 20 determines that the SOC is equal to or greater than the predetermined value (step S24: Yes), the processing exits this flow. In this case, since all the conditions in steps S22 to S24 are satisfied, the controller 20 continues the hill-climbing control according to the present embodiment. On the other hand, if the controller 20 does not determine that the SOC is equal to or greater than the predetermined value (step S24: No), that is, if the SOC is less than the predetermined value, the processing proceeds to step S25. In this case, the SOC (the charge amount) of the battery 4 is not an amount with which the vehicle can climb by the motor torque using the electric power of the battery 4. Accordingly, in step S25, in order to terminate the hill-climbing control according to the present embodiment (more specifically, in order to terminate the hill-climbing control, set the hybrid travel mode, and climb by using the engine torque), the controller 20 executes the control to disengage the lock-up clutch 6, and simultaneously executes the control to engage the first clutch CL1 in step S26.

### Operation and Effects

Next, operation and effects of the control system 1 for the vehicle according to the present embodiment will be described. According to the present embodiment, in the case where the torque converter temperature becomes equal to or higher than the predetermined temperature while the vehicle travels on the uphill road by using at least the engine torque, the controller 20 engages the lock-up clutch 6 and disengages the first clutch CL1. Since the transmission loss in the torque converter 5 can be suppressed by engaging the lock-up clutch 6 as described above, the heat generation of the torque converter 5 during hill climbing can be suppressed. In addition, since the transmission of the engine torque to the downstream side is interrupted by disengaging the first clutch CL1, only the motor torque is transmitted to the downstream side. Thus, the vehicle can climb by using the motor torque, and the engine stall, which is caused by operation of the engine 2 at a low speed during hill climbing, can be prevented.

According to the present embodiment, the controller 20 engages the lock-up clutch 6, disengages the first clutch CL1, and causes the engine 2 to idle. In this way, it is no longer necessary to secure the surplus power of the motor 3 for the engine start, and the vehicle can reliably climb by the motor torque.

According to the present embodiment, the controller 20 engages the lock-up clutch 6, disengages the first clutch CL1, and increases the motor torque. As a result, the vehicle can reliably climb by the motor torque.

According to the present embodiment, in the case where the road surface gradient of the uphill road is equal to or greater than the predetermined value, the controller 20 engages the lock-up clutch 6 and disengages the first clutch CL1. As a result, it is possible to execute the control to engage the lock-up clutch 6 and disengage the first clutch CL1 on the relatively steep uphill road on which the heat generation of the torque converter 5 occurs.

According to the present embodiment, when the vehicle speed is lower than the predetermined speed, the controller 20 engages the lock-up clutch 6 and disengages the first clutch CL1. As a result, it is possible to execute the control to engage the lock-up clutch 6 and disengage the first clutch CL1 at such a relatively low vehicle speed that the heat generation of the torque converter 5 occurs.

According to the present embodiment, when the SOC of the battery 4 is equal to or greater than the predetermined value, the controller 20 engages the lock-up clutch 6 and disengages the first clutch CL1. As a result, when the SOC (the charge amount) of the battery 4 is an amount capable of causing the vehicle to climb by the motor torque using the electric power of the battery 4, it is possible to execute the control to engage the lock-up clutch 6 and disengage the first clutch CL1.

According to the present embodiment, in the case where the torque converter temperature becomes lower than the predetermined temperature after the lock-up clutch 6 is engaged and the first clutch CL1 is disengaged, the controller 20 disengages the lock-up clutch 6 and engages the first clutch CL1. As a result, when the torque converter temperature is relatively low and it is no longer necessary to suppress the heat generation of the torque converter 5, it is possible to disengage the lock-up clutch 6 and engage the first clutch CL1.

According to the present embodiment, in the case where the vehicle speed becomes equal to or higher than the predetermined speed after the lock-up clutch 6 is engaged and the first clutch CL1 is disengaged, the controller 20 disengages the lock-up clutch 6 and the first clutch CL1 is engaged. As a result, when the vehicle speed is relatively high, and it is no longer necessary to suppress the heat generation of the torque converter 5, it is possible to disengage the lock-up clutch 6 and engage the first clutch CL1.

According to the present embodiment, in the case where the SOC of the battery 4 becomes less than the predetermined value after the lock-up clutch 6 is engaged and the first clutch CL1 is disengaged, the controller 20 disengages the lock-up clutch 6 and engages the first clutch CL1. As a result, when the SOC (the charge amount) of the battery 4 becomes an amount incapable of causing the vehicle to climb by the motor torque using the electric power of the battery 4, hill climbing by using the engine torque is enabled by disengaging the lock-up clutch 6 and engaging the first clutch CL1.

### Modified Examples

In the embodiment described above, the engine 2 idles, that is, the engine 2 does not substantially generate the torque. However, in a modified example, the engine 2 may be operated to generate the torque, and hill climbing using the motor torque may be assisted by the engine torque, that is, the engine torque may be used for hill climbing in addition to the motor torque. In this case, the first clutch CL1 may be brought into a half-engaged state, and the engine torque may be transmitted to the motor 3 side. For example, when the SOC of the battery 4 becomes low, such control may be executed. The present disclosure encompasses various modifications to each of the examples and embodiments discussed herein. According to the disclosure, one or more features described above in one embodiment or example can be equally applied to another embodiment or example described above. The features of one or more embodiments or examples described above can be combined into each of the embodiments or examples described above. Any full or partial combination of one or more embodiment or examples of the disclosure is also part of the disclosure.

### REFERENCE SIGNS LIST

1: control system for vehicle
2: engine
3: motor
4: battery
5: torque converter
6: lock-up clutch
7: transmission
8: power transmission system
10: driveshaft
12: drive wheel
20: controller
CL1: first clutch
CL2: second clutch

1. A control system for a vehicle comprising:
an engine and a motor that generate torque for driving a vehicle;
a frictional engagement element that is provided between the engine and the motor in an engageable/disengageable manner;
a transmission, a torque converter, and a lock-up clutch that are provided on a power transmission path between the motor and a drive wheel of the vehicle; and
controller circuitry configured to control the engine, the motor, the frictional engagement element, and the lock-up clutch, wherein
the controller circuitry is configured to engage the lock-up clutch and disengage the frictional engagement element in the case where a temperature of the torque converter becomes equal to or higher than a predetermined temperature while the vehicle travels on an uphill road by using at least the torque of the engine.

2. The control system for a vehicle according to claim 1, wherein
the controller circuitry is configured to engage the lock-up clutch, disengage the frictional engagement element, and cause the engine to idle.

3. The control system for a vehicle according to claim 2, wherein
the controller circuitry is configured to engage the lock-up clutch, disengage the frictional engagement element, and increase the torque of the motor.

4. The control system for a vehicle according to claim 2, wherein
the controller circuitry is configured to engage the lock-up clutch and disengage the frictional engagement element when a road surface gradient of the uphill road is equal to or greater than a predetermined value.

5. The control system for a vehicle according to claim 2, wherein
the controller circuitry is configured to engage the lock-up clutch and disengage the frictional engagement element when a vehicle speed of the vehicle is lower than a predetermined speed.

6. The control system for a vehicle according to claim 2, wherein
the controller circuitry is configured to engage the lock-up clutch and disengage the frictional engagement element when an SOC of a battery that supplies electric power to the motor is equal to or greater than a predetermined value.

7. The control system for a vehicle according to claim 2, wherein
the controller circuitry is configured to disengage the lock-up clutch and engage the frictional engagement element in the case where a temperature of the torque converter becomes lower than a predetermined temperature after the lock-up clutch is engaged and the frictional engagement element is disengaged.

8. The control system for a vehicle according to claim 2, wherein
the controller circuitry is configured to engage the frictional engagement element in the case where a vehicle speed of the vehicle becomes equal to or higher than a predetermined speed after the lock-up clutch is engaged and the frictional engagement element is disengaged.

9. The control system for a vehicle according to claim 2, wherein
the controller circuitry is configured to disengage the lock-up clutch and engage the frictional engagement element in the case where an SOC of a battery that supplies electric power to the motor becomes less than a predetermined value after the lock-up clutch is engaged and the frictional engagement element is disengaged.

10. The control system for a vehicle according to claim 1, wherein
the controller circuitry is configured to engage the lock-up clutch, disengage the frictional engagement element, and increase the torque of the motor.

11. The control system for a vehicle according to claim 1, wherein
the controller circuitry is configured to engage the lock-up clutch and disengage the frictional engagement element when a road surface gradient of the uphill road is equal to or greater than a predetermined value.

12. The control system for a vehicle according to claim 1, wherein
the controller circuitry is configured to engage the lock-up clutch and disengage the frictional engagement element when a vehicle speed of the vehicle is lower than a predetermined speed.

13. The control system for a vehicle according to claim 1, wherein
the controller circuitry is configured to engage the lock-up clutch and disengage the frictional engagement element when an SOC of a battery that supplies electric power to the motor is equal to or greater than a predetermined value.

14. The control system for a vehicle according to claim 1, wherein
the controller circuitry is configured to disengage the lock-up clutch and engage the frictional engagement element in the case where a temperature of the torque converter becomes lower than a predetermined temperature after the lock-up clutch is engaged and the frictional engagement element is disengaged.

15. The control system for a vehicle according to claim 1, wherein
the controller circuitry is configured to engage the frictional engagement element in the case where a vehicle speed of the vehicle becomes equal to or higher than a predetermined speed after the lock-up clutch is engaged and the frictional engagement element is disengaged.

16. The control system for a vehicle according to claim 1, wherein
the controller circuitry is configured to disengage the lock-up clutch and engage the frictional engagement element in the case where an SOC of a battery that supplies electric power to the motor becomes less than a predetermined value after the lock-up clutch is engaged and the frictional engagement element is disengaged.

17. A control method for a vehicle comprising:
an engine and a motor that generate torque for driving a vehicle;
a frictional engagement element that is provided between the engine and the motor in an engageable/disengageable manner;
a transmission, a torque converter, and a lock-up clutch that are provided on a power transmission path between the motor and a drive wheel of the vehicle,
the control method comprising:
engaging the lock-up clutch and disengaging the frictional engagement element when a temperature of the torque converter is equal to or higher than a predetermined temperature while the vehicle travels on an uphill road by using at least the torque of the engine.

18. The control method according to claim 17, further comprising engaging the lock-up clutch and disengage the frictional engagement element when a road surface gradient of the uphill road is equal to or greater than a predetermined value.

19. The control method according to claim 17, further comprising engaging the lock-up clutch and disengage the frictional engagement element when a vehicle speed of the vehicle is lower than a predetermined speed.

20. A non-transitory computer-readable storage medium having computer-executable instructions stored thereon, which when executed by a processor, cause the processor to perform a control method for a vehicle comprising:
an engine and a motor generate torque for driving a vehicle;
a frictional engagement element that is provided between the engine and the motor in an engageable/disengageable manner;
a transmission, a torque converter, and a lock-up clutch that are provided on a power transmission path between the motor and a drive wheel of the vehicle,
the control method comprising:
engaging the lock-up clutch and disengaging the frictional engagement element when a temperature of the torque converter is equal to or higher than a predetermined temperature while the vehicle travels on an uphill road by using at least the torque of the engine.
